(19) United States
(12) Patent Application Publication
(10) Pub. No.: US 2005/0183303 A1
(43) Pub. Date: Aug. 25, 2005

(54) Method and an arrangement for adveratising or promoting

(76) Inventors: Peter A. Simonsen, Copenhagen N (DK); Morten C. Andersen, Copenhagen K (DK)

Correspondence Address: KLEIN, O'NEILL & SINGH, 2 PARK PLAZA, SUITE 510, IRVINE, CA, 92614, US

(21) Appl. No.: 10/500,984

(22) PCT Filed: Apr. 20, 2004
(86) PCT No.: PCT/DK04/00273

(30) Foreign Application Priority Data
Aug. 15, 2003 (DK) PA 2003 01172
Oct. 15, 2003 (DK) PA 2003-01520

(51) Int. Cl. G09F 13/00

(52) U.S. Cl. 40/560; 353/30

(57) ABSTRACT

A method and apparatus for displaying an advertising or promotional image or message provides the projection of one or more light patterns, and still or motion pictures within the light patterns, onto a visible surface or screen. The outline of the surface or screen may be identical to the outline of the projected light pattern.

The present invention relates to a method of advertising or promoting. More specifically, the invention provides projection of light pattern(s) and of pictures within said light pattern(s), and where the outline of the surface or screen, onto which it is projected, may be identical to the outline of the projected light pattern. The invention also relates to an arrangement for advertising or promoting.

### BACKGROUND OF THE INVENTION

Different kinds of equipment used for presentation of information are known from the prior art.

U.S. Pat. No. 4,739,567 discloses an image projection system for projecting and displaying images at billboard or signboard scale in which a building window defines the display aperture of the image projection system for viewing projected images from outside the building.

EP 0 097 132 discloses a light panel with interchangeable mobile characters. A vertical face of the box is a fixed or removable opaque sheet in which square windows are arranged in equidistant horizontal and vertical lines. The letters are formed by partial blackening of transparent rectangular tiles, which slide along horizontal grooves formed in the face above and below each row of windows. The letter appears centrally in each window and is illuminated from within by a single filament lamp.

WO 93/07605 discloses a sign plate having indicia that forms visual communication matter, said sign plate being for use in a sign that has a light source for illuminating the indicia, the sign including an opaque reflective layer on its face that receives light from the light source.

NL 1008566 discloses an illuminated advertising sign, name display or logo. The sign is encased by a front panel, sides and a rear panel. The translucent character protrudes through gaps in the opaque front panel. A cover plate retains the edges of the front panel onto the rear casing. One or more conventional florescent tubes are fitted at the rear of the case.

Other arrangements for presentation of information are described in WO 89/11235, U.S. Pat. No. 4,196,449, U.S. Pat. No. 5,736,975 and U.S. Pat. No. 5,936,671.

### DESCRIPTION OF THE INVENTION

The present invention provides a method of advertising or promoting comprising:
projecting a light pattern comprising one or more illuminated areas onto a visible surface or screen, said light pattern defining a message or announcement area, and
projecting still or motion pictures into said illuminated area(s).

The visible surface or screen could, for example, be defined by openings in one or more plates and/or be one or more plate(s) arranged in front of a projector. Thus, the screen could be defined by openings cut in a plate or by plate(s) made of e.g. plastic, wood, aluminium or steel. Alternatively, and presently preferred, the surface or screen may be composed by glass or plastic material, in particular an acrylic material. The material may be transparent or at least translucent.

In order to deflect and/or transmit the light a layer of image forming material, such as translucent material, may be placed in front of the projector and before the visible surface or screen and which “catches” the light so that the viewer can see the projected light and pictures. Thus, a translucent material, such as a frost filter film may be provided between the projector and the screen onto which the light pattern and pictures are projected. The projected light and pictures may then be deflected and/or transmitted by said film in order to present visible light and pictures to a viewer positioned at and spaced from the side of the screen being opposite to the projector (also called “back projection”). The frost material may comprise a separate plate or plates of material positioned between the projector and screen, or the frost material may be provided on a side of the plate or the material of the plate may be translucent itself. In case the screen comprises openings in a plate, as mentioned above, translucent material may be placed at least behind said openings, or if the screen comprises one or more plates (e.g. defining a logo), at least the backside of said plates may be translucent. In general, it's a matter of providing a layer of non-transparent but translucent material that “catches” the light, also called a “diffusion screen”.

The idea of providing still or motion pictures in a projected light pattern is useful as sales advertisement and promotion tool and may belong to the category of “display systems”. The idea is to create a connection between e.g. a company and what it produces or sells. Thus, the illuminated areas may define a logo of a company or anything else, and with the living pictures inside the logo, a story is presented to a viewer looking at the logo. An example could be a logo for Coca Cola® where people drinking Coca Cola® are shown in the illuminated areas forming the logo.

Preferably, the outline(s) of the illuminated areas is/are substantially identical to the outline(s) of the openings and/or said plate(s) of the screen. Thus, the projected light from the projector may exactly fit to the shape of the plates or openings positioned in front of the projector. The distance between the projector and the screen or plates may be adjusted so that edges of the illuminated areas are totally coincident with the edges of the openings or plates defining screen.

However, the outlines of the illuminated areas need not be identical to the openings and/or plate(s), the illuminated areas may for example be larger than the outline of the openings or plates. In one embodiment, the light pattern comprises illuminated areas, such as a logo, having outlines identical to the outline of the opening(s) or plate(s), but furthermore the light pattern comprises illuminated areas that are projected onto a part of the surface or screen that surrounds the opening(s) or plates, said part may be of transparent or at least translucent material. The illuminated areas projected onto the part of the surface or screen that surrounds the openings or plates may comprise any light pattern or still or motion pictures.

In case the surface or screen comprises plates (and not openings), said plates may be provided in a board or this-like and may for example be provided as projections on said board. In that case the plates defining the surface or screen may be of e.g. translucent material, and the transition between said plates and the board and the board may be of transparent material.

In order to obtain that the above light pattern and thus the illuminated areas become identical to the shape of the opening or plates of the screen or visible surface defining e.g. a logo, the projected light pattern may be provided by editing a digital image of said logo defining areas to be illuminated, the method comprising the following image processing steps:
darkening the part of the image outside said areas,
cleaning the colours from said areas, and
drawing up the contours of said areas in the image with a coloured non-black line.

The result of the above editing will be an image showing the illuminated areas in a sharp edged preferably white coloured form on a dark background. Now, the projector will project light identical to the edited image, and by adjusting the distance to the screen the projected contours (or sharp edges) of the light pattern will be coincident with the contours of the visible surface or screen defining the logo.

When editing it may be advantageous to use “an alpha key” for providing said light pattern.

Based on the edited image of the illuminated areas, it is possible to put in still or motion pictures in each of the illuminated areas, so that e.g. a movie may be played in each letter or separate part of a logo. In order to provide these pictures, the method further comprises the step of editing captured still or motion pictures in order to have said pictures projected within said area(s) defined by said non-black line. Different still or motion pictures may be shown in different illuminated areas.

Preferably, the step of darkening comprises providing the colour type “black level 0” on the background. Thus, light is only transmitted on the visible surface or screen and not outside the edges of the visible surface or screen, as the projector then does not waste any light outside the screen which is important.

There may be one or more video projectors or computer controlled video projectors for projecting said light pattern and pictures, and the video projector may project said light pattern and pictures in a 4:3 format or 16:9 format.

The motion pictures may show objects and/or living beings.

The projector and screen may be positioned on the roof of building or on the ceiling or floor of a room, whereby the projector may be placed concealed or invisible to the viewer.

The logo formed by the illuminated areas may have any shape, such as an icon standing alone or as letters hanging over a main entrance to a store, or mounted on the roof of a building showing living pictures or elements within letters. In the latter, the viewer will see letters and elements standing apart with motion pictures inside each letter or elements. It may be advantageous to create a clearly visible borderline along outlines or edges of the logo (or icon) parts as this will provide a certain 3-dimensional effect to a viewer viewing the video logo, e.g. from the street, through a window and into a store where the projection arrangement is provided.

The visible surface or the visible side of the screen may be that opposite to the projector, so that the light and pictures are back projected on the screen in relation to the viewer. However, the viewer may view the light pattern and pictures from the other side of the screen too.

Preferably, the image processing is provided by an image-editing program on a computer, and the editing of the captured still or motion picture is provided by a video editing program.

Though, it is mentioned that the screen or visible surface is provided in or by plates, the screen may be provided by any kind of object that may work as a “diffusion screen”.

According to a second aspect, the present invention relates to an advertisement or promotion arrangement that comprises means for projecting a light pattern comprising one or more illuminated areas defining a message or announcement area, a visible surface or screen onto which said light pattern is projected, and means for projecting still or motion pictures into said illuminated areas.

The arrangement may comprise any of the features mentioned above in connection with the first aspect, and it may be used to carry out said method.

### DESCRIPTION OF THE FIGURES

FIG. 1 shows an arrangement according to the invention, wherein the screen is defined by openings in a plate,

FIG. 2 shows the final result of the projection of the arrangement in FIG. 1, and

FIG. 3 shows an arrangement according to the invention, wherein the screen is provided by plates forming letters of a logo, and

FIGS. 4-9 shows different embodiments of projections.

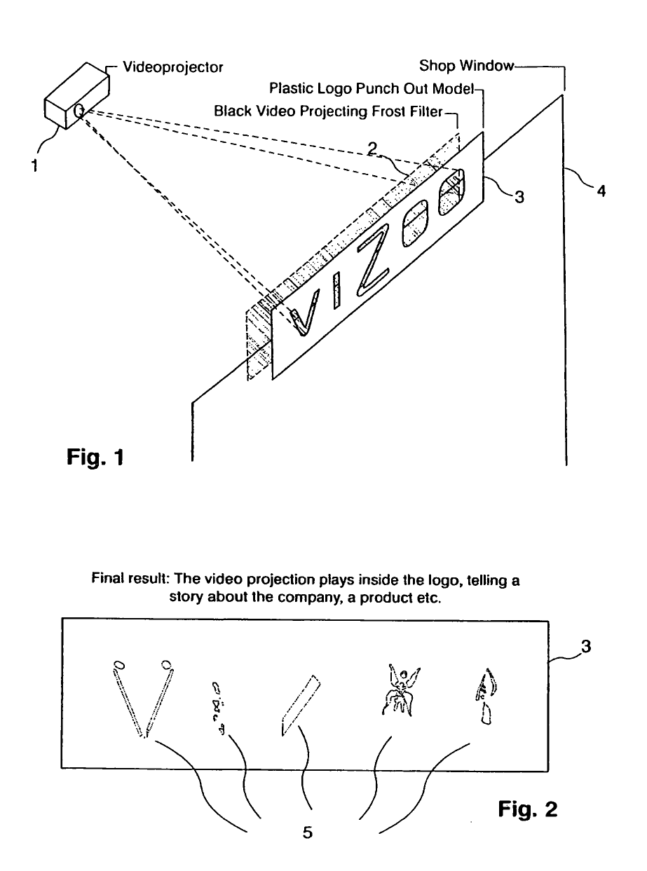

FIG. 1 shows the arrangement according to the invention. A video projector 1 projects the light pattern and the still or motion pictures. A frost filter 2 is provided behind the plate 3 wherein the logo/screen is cut (“Vizoo”) for obtaining the projected light pattern and motion pictures. The viewer will see motion pictures 5 in the letters of the logo 3 from the window side 4 on the opposite side of the logo 3 in relation to the projector, as shown in FIG. 2.

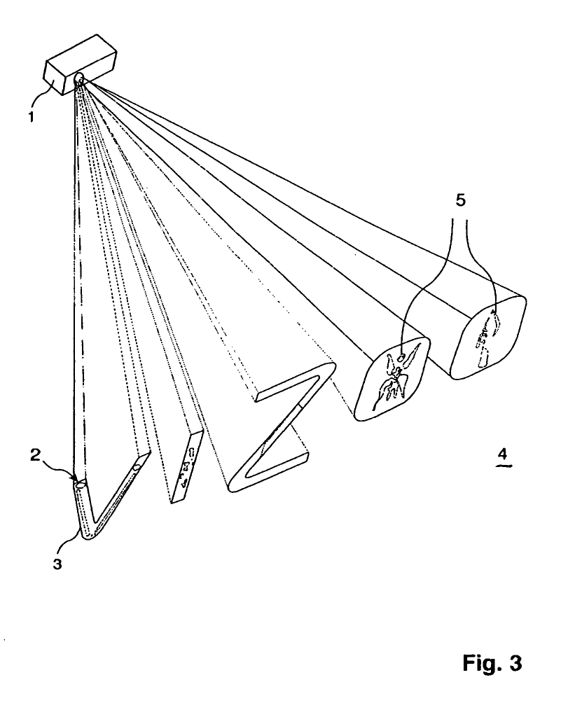

FIG. 3 shows an arrangement where letters 3 that are cut out from a material, preferably acrylic material, provides the screen onto which the light and pictures are projected. The side of the acrylic material facing the projector has a frost side 2, such as a frost film filter, in order to deflect/transmit the light and pictures being projected from the projector 1. Thus, the viewer will see the motion pictures 5 in the letters from the opposite side 4 of the screen in relation to the projector 1.

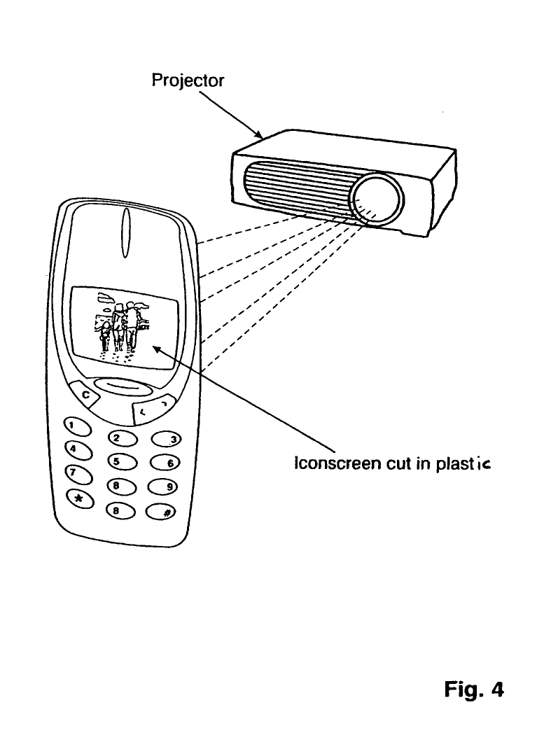

FIG. 4 shows a projection of an icon of a mobile phone, and wherein still or motion pictures are projected in the area defined by the display of the mobile phone. The screen is cut out in plastic material, and the shape of the projected light pattern is identical to the shape of the screen. If the projector is turned off, the viewer will only see a frost plastic plate having the contour of the mobile phone, but not the mobile phone and the motion pictures in the display.

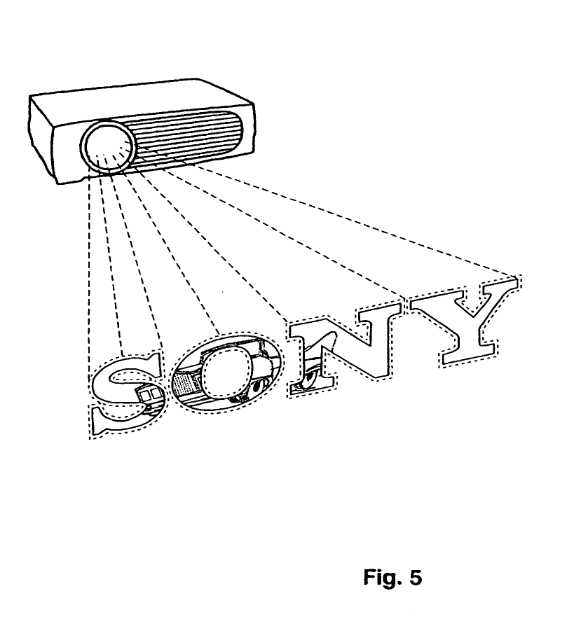

FIG. 5 shows the same embodiment as shown in FIG. 3, but with a different screen (logo).

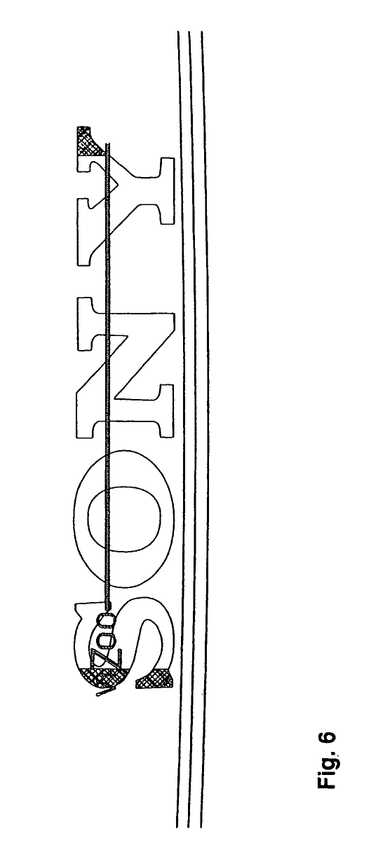

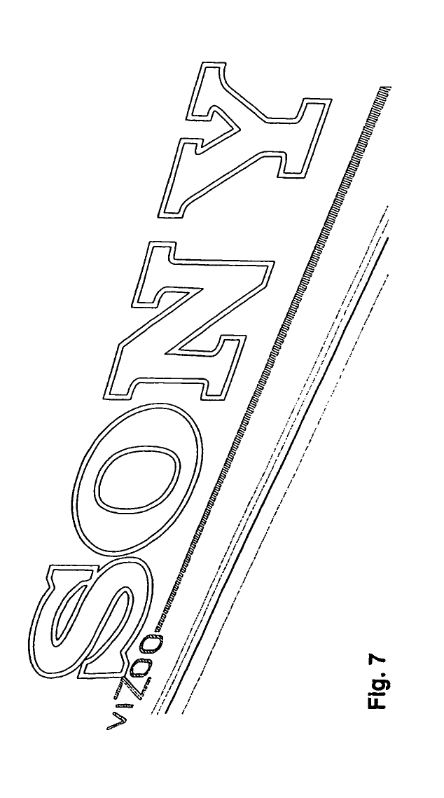

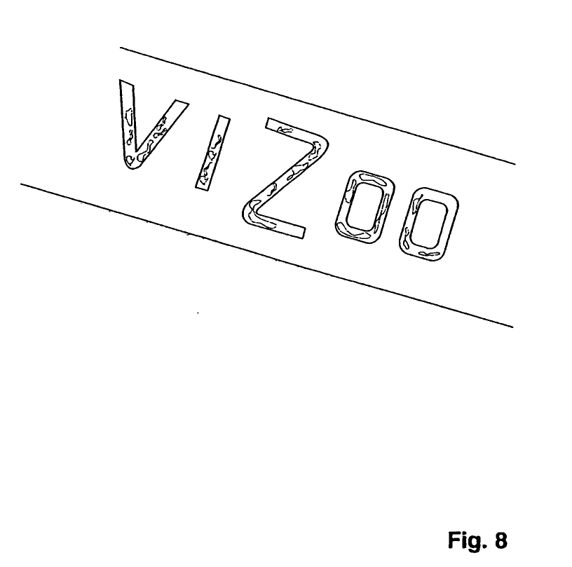

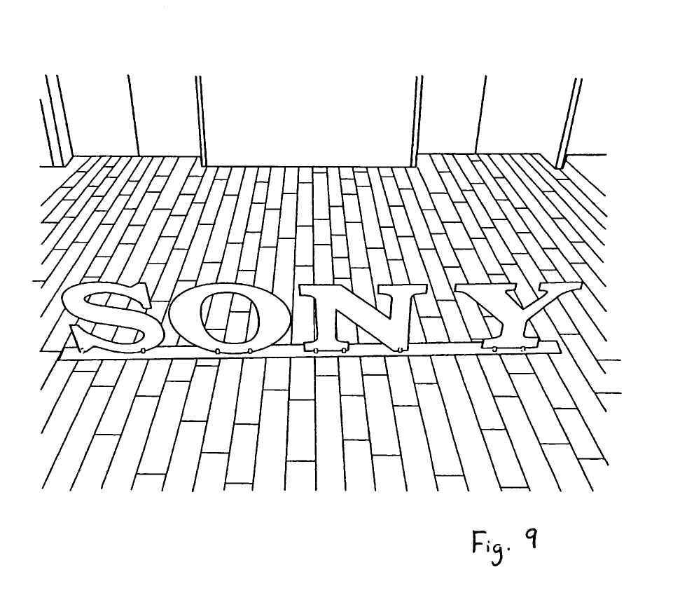

FIGS. 6-9 shows projections according to the invention, wherein the screen is formed as a logo, such as Sony®, defined by adjacent positioned plates each defining a letter of the logo. The plates are made of acrylic material and have a frost side facing the projector in order to make it translucent. Thus, a diffusion screen is provided.

An embodiment of the method of editing the contents of the video material (still or motion pictures) will now be described:

Firstly, a logo is provided in a digital version that is transferred to an image-editing program in a computer. The background of the logo is covered with black colour (black level 0), and then the logo is cleaned for colours and patterns inside the logo, e.g. inside the letters of the logo. Using an alpha key behind the logo best does this. It is advantageous to have a graphical outline, which will provide a more 3-dimensional effect in the final projection.

Now, the logo is ready to be filled up with still or motion pictures e.g. inside its letters, which is done in the video editing program. Preferably, the logo is in EPS-format (the same logo-format that may be used to produce/cut out the screen) and used as mask for the editing of the video material. A thin coloured line is drawn along the edge of the mask and thus shows the logo even in a dark video picture. The video material (still or motion pictures) is placed in the remaining mask of the logo so that the entire logo is filled up with pictures. The final video movie now consists of a 4:3 format where everything else than the logo is dark.

1. A method of advertising or promoting, said method comprising;
projecting a light pattern comprising one or more illuminated areas from a projector onto a screen, said light pattern defining a message or announcement area, and
projecting a picture from projector onto said screen into said one or more illuminated areas;
wherein outlines of said one or more illuminated areas correspond to outlines of the screen.

2-6. (canceled)

7. A method according to claim 1, wherein the illuminated areas define a logo.

8. A method according to claim 1, wherein the projected light pattern is provided by editing a digital image defining said areas to be illuminated in order to provide a mask, the method comprising the following image processing steps of:
darkening the part of the image surrounding said areas,
cleaning the colors from within said areas, and
drawing up the contours of said areas in the picture with a colored non-black line.

9. A method according to claim 8, further comprising the step of editing captured pictures by use of said mask in order to have said pictures projected within said areas defined by said non-black line.

10. A method according to claim 1, wherein different pictures are shown in different illuminated areas.

11. A method according to claim 8, wherein the step of editing the image comprises using an alpha key.

12. A method according to claim 8, wherein the step of darkening comprises providing the color type “black level 0” on the part surrounding said areas.

13-14. (canceled)

15. A method according to claim 1, wherein the pictures are motion pictures showing objects selected from the group consisting of at least one of inanimate objects and living beings.

16. (canceled)

17. A method according to claim 8, wherein the image processing is provided by an image-editing program on a computer.

18. A method according to claim 9, wherein the editing of the captured picture is provided by a video-editing program.

19-23. (canceled)

24. An advertisement or promotion arrangement, said arrangement comprising:
means for projecting a light pattern comprising one or more illuminated areas defining a message or announcement area,
a screen onto which said light pattern is projected,
means for projecting pictures into said one or more illuminated areas, and
means for editing a digital image to define said one or more illuminated areas so that outlines of the one or more illuminated areas correspond to outlines of the screen.

25. An arrangement according to claim 24, wherein the means for projecting comprises one or more projectors.

26. (canceled)

27. An arrangement according to claim 24, wherein the screen is made of a material selected from the group consisting of at least one of plastic, wood, aluminum, steel and acrylic material.

28. An arrangement according to claim 24, wherein the screen is translucent.

29-30. (canceled)

31. An arrangement according to claim 27, wherein the acrylic material comprises a frosted side onto which the light pattern aid pictures are projected.

32. An arrangement according to claim 24, wherein the one or more illuminated areas define a logo.

33. An arrangement according to claim 24, wherein said means for editing a digital image comprise:
means for darkening the part of the image surrounding said one or more illuminated areas,
means for cleaning the colors from within said one or more illuminated areas, and
means for drawing up the contours of said one or more illuminated areas in the picture with a colored non-black line.

34. An arrangement according to claim 33, further comprising means for editing captured pictures by use of said mask in order to have said pictures projected within said non-black line.

35. (canceled)

36. An arrangement according to claim 33, wherein the digital image is edited by use of an alpha key.

37. An arrangement according to claim 33, wherein the color type on the part surrounding the areas is “black level 0” after darkening.

38-42. (canceled)

43. An arrangement according to claim 24, wherein the screen comprises one or more adjacent screens.

44-46. (canceled)

47. A method according to claim 1, wherein the picture comprises a still picture.

48. A method according to claim 1, wherein the picture comprises motion pictures.

49-56. (canceled)

57. An arrangement according to claim 24, wherein the screen is arranged in front of a projector projecting at least one of the light pattern and the pictures.

58-63. (canceled)
